(19) United States
(12) Patent Application Publication
(10) Pub. No.: US 2026/0084081 A1
(43) Pub. Date: Mar. 26, 2026

(54) METHOD AND APPARATUS FOR CHALLENGE DISTRIBUTION

(71) Applicant: American Air Filter Company, Inc., Louisville, KY (US)

(72) Inventors: Ronald W. Graves, New Bern, NC (US); Joshua Ray Selby, Washington, NC (US); Robert Dunn, JR., Washington, NC (US); Jonathan Holland, Washington, NC (US); Donald Jonathan Largent, Hampstead, MD (US); Andrew Duncan, Washington, NC (US)

(21) Appl. No.: 18/891,848

(22) Filed: Sep. 20, 2024

(51) Int. Cl. B01D 46/00; B01D 46/42

(52) U.S. Cl. CPC B01D 46/0005; B01D 46/42

(57) ABSTRACT

A method and apparatus for challenge distribution in a filter unit. A filter housing may include one or more aerosol injectors supporting one or more walls of the filter housing. One or more walls of the filter housing may define a portion of the aerosol injector and/or mixing chamber. The aerosol injector may include a plurality of openings in fluid communication with a mixing chamber. The aerosol injector may include one or more fittings. The filter housing may include one or more air circulating devices.

### BACKGROUND

The present embodiments relate to a filter housing, with particular embodiments shown for a filter unit for distributing aerosol challenge.

Typical fan filter units introduce aerosol challenge directly into the fan inlet via an injection tube and/or rely on the fan blade contact to provide a consistent uniform challenge. This may lead to inconsistencies including, but is not limited to, aerosol challenge accumulation on the fan and/or walls and/or inconsistent distribution across the filter face. Thus, there is a need for consistent uniform aerosol challenge across the filter face.

### SUMMARY

In some embodiments of the invention, for example, a filter housing may include a housing having a plurality of housing walls defining an interior volume. In various embodiments, the housing is configured to position one or more filters. In some embodiments, the filter housing may include one or more aerosol injectors having one or more walls defining one or more mixing chambers. In various embodiments, the one or more aerosol injectors may be one or more support struts of one or more housing walls of the plurality of housing walls. In some embodiments, the one or more housing walls may be a side wall(s), a top wall(s), and/or a bottom wall(s).

In addition, in some embodiments, the filter housing may include an air circulating device. In various embodiments, the housing may be configured to position the air circulating device relative to one or more filters. In some embodiments, the one or more housing walls of the plurality of housing walls may define a portion of the one or more mixing chambers. In various embodiments, the filter housing may include a fitting having at least two outlets within the one or more mixing chambers of the one or more aerosol injectors directing aerosol in opposing directions. In some embodiments, at least two outlets may include two opposing outlets. In various embodiments, an axis of the two opposing outlets, respectively, may be substantially parallel to a longitudinal axis of the one or more aerosol injectors. In some embodiments, the one or more housing walls may include at least one side wall and a top wall. In various embodiments, the one or more mixing chambers may be defined by at least the top wall and/or the at least one side wall. In some embodiments, the one or more mixing chambers may be defined by the top wall. In various embodiments, the one or more mixing chambers may be defined by the top wall and the at least one side wall. In some embodiments, the one or more walls of the aerosol injector may be planar. In various embodiments, the one or more walls may include a plurality of openings in communication between the one or more mixing chambers and the interior volume. In some embodiments, two walls of the one or more walls may include at least one opening of the plurality of openings. In various embodiments, an axis of at least one opening of each of the two walls may be transverse to each other. In some embodiments, the one or more mixing chambers may be non-arcuate in cross section. In various embodiments, the aerosol injector may include one or more flanges projecting from the one or more walls engaging the one or more housing walls.

In some embodiments, a filter housing may include a housing having a top wall, bottom wall, and/or one or more side walls defining an interior volume. In various embodiments, the housing may be configured to position one or more filters. In some embodiments, the filter housing may include one or more aerosol injectors having one or more walls defining one or more mixing chambers. In various embodiments, the one or more aerosol injectors may be one or more support struts of at least one of the top wall(s), bottom wall(s), and/or one or more side walls.

In addition, in some embodiments, the filter housing may include an air circulating device. In various embodiments, the housing may be configured to position the air circulating device relative to one or more air filters. In some embodiments, the one or more mixing chambers may be defined by at least the top wall. The various embodiments, one or more mixing chambers may be defined by at least one of the top wall and/or the one or more side walls. In some embodiments, the one or more mixing chambers may be defined by at least the bottom wall. The various embodiments, one or more mixing chambers may be defined by at least the bottom wall and the one or more side walls. In some embodiments, the one or more side walls and/or one or more support struts define one or more ends of the one or more aerosol injectors. In some embodiments, the one or more bottom/top walls and/or one or more support struts define one or more ends of the one or more aerosol injectors. In various embodiments, the one or more aerosol injectors may include a fitting. In some embodiments, the fitting spaces one or more outlets and/or aerosol into the mixing chamber away from the one or more walls of the one or more aerosol injectors. In various embodiments, the fitting may be in downstream communication with one or more aerosol delivery tubes to an aerosol access port accessible from outside the housing. In some embodiments, the one or more walls of the aerosol injector may include a plurality of openings in communication between the one or more mixing chambers and the interior volume. In various embodiments, one or more flanges may project from the one or more walls engaging at least one of the top wall(s), bottom wall(s), and/or one or more side walls.

In addition, in some embodiments, a method of injecting aerosol in a filter housing may include providing a filter housing having one or more housing walls defining an interior volume. In various embodiments, the filter housing may include one or more support struts adjacent to and/or supporting the one or more housing walls (e.g. interior periphery, surfaces). In some embodiments, the one or more support struts may include one or more openings therein. In various embodiments, the method may include injecting aerosol to or into the one or more support struts from an aerosol access port accessible from outside the filter housing.

In addition, in some embodiments, the method may include injecting aerosol in opposing directions within a mixing chamber defined by the one or more support struts. In various embodiments, the mixing chamber may be defined by the one or more housing walls and the one or more support struts. In some embodiments, the method may include communicating aerosol through the one or more openings transverse to a top/bottom wall of the one or more housing walls of the filter housing from the one or more support struts to the interior volume. In various embodiments, the method may include mixing the injected aerosol and air in a mixing chamber defined by the one or more housing walls of the filter housing and one or more walls of the one or more support struts. In some embodiments, the filter housing may include one or more air circulating devices in fluid communication with the one or more support struts

These and other advantages and features, which characterize the embodiments, are set forth in the claims annexed hereto and form a further part hereof. However, for a better understanding of the embodiments, and of the advantages and objectives attained through its use, reference should be made to the drawings and to the accompanying descriptive matter, in which there are described example embodiments. This summary is merely provided to introduce a selection of concepts that are further described below in the detailed description, and is not intended to identify key or essential features of the claimed subject matter, nor is it intended to be used to limit the scope of the claimed subject matter, nor to define the field of endeavor.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a top perspective view of one embodiment of a filter unit with portions of the filter housing/unit broken away, illustrating an embodiment of aerosol being injected into one or more mixing chambers of one or more support struts;

FIG. 2 is a bottom perspective view of the filter unit of FIG. 1;

FIG. 3 is a top perspective view of the support struts and aerosol tubing;

FIG. 4 is a sectional view taken along line 4-4 of FIG. 1;

FIG. 5 is a top perspective view of a filter unit with portions of the filter housing/unit broken away, illustrating another embodiment of aerosol being injected into one or more mixing chambers of one or more support struts;

FIG. 6 is a bottom perspective view of the filter unit of FIG. 5;

FIG. 7 is a top perspective view of the support struts and aerosol tubing;

FIG. 8 is a sectional view taken along line 8-8 of FIG. 5;

FIG. 9 is a top perspective view of a filter unit with portions of the filter housing/unit broken away, illustrating another embodiment of aerosol being injected into one or more mixing chambers of one or more support struts;

FIG. 10 is a bottom perspective view of the filter unit of FIG. 9;

FIG. 11 is a top perspective view of the support struts and aerosol tubing;

FIG. 12 is a sectional view taken along line 12-12 of FIG. 9;

FIG. 13 is a top perspective view of another embodiment of a filter unit with portions of the filter housing/unit broken away, illustrating an embodiment of aerosol being injected into one or more mixing chambers of one or more support struts;

FIG. 14 is a bottom perspective view of the filter unit of FIG. 13;

FIG. 15 is a sectional view taken along line 15-15 of FIG. 13; and

FIG. 16 is a sectional view of another embodiment of a filter unit with portions of the filter housing/unit broken away, illustrating an embodiment of aerosol being injected into one or more mixing chambers of one or more support struts.

### DETAILED DESCRIPTION

Numerous variations and modifications will be apparent to one of ordinary skill in the art, as will become apparent from the description below. Therefore, the invention is not limited to the specific implementations discussed herein.

The embodiments discussed hereinafter will focus on the implementation of the hereinafter-described techniques for a filter unit/system 10, such as the type that may be used in an industrial, commercial, and/or residential environments such as, but is not limited to, pharmaceutical manufacturing facilities, biotechnology research labs, structures for housing, buildings, clean rooms, or in other similar applications. However, it will be appreciated that the herein-described apparatus and techniques may also be used in connection with other types of filter housings in some embodiments. For example, the herein-described apparatus and techniques may be used in filter testing systems in some embodiments. The filter system 10 and/or filter housing 30 may include one or more aerosol injectors 20 to consistently mix the aerosol to create the uniform challenge aerosol across the filter face and/or to perform statistically valid tests for certification of the filter(s) for one or more applications.

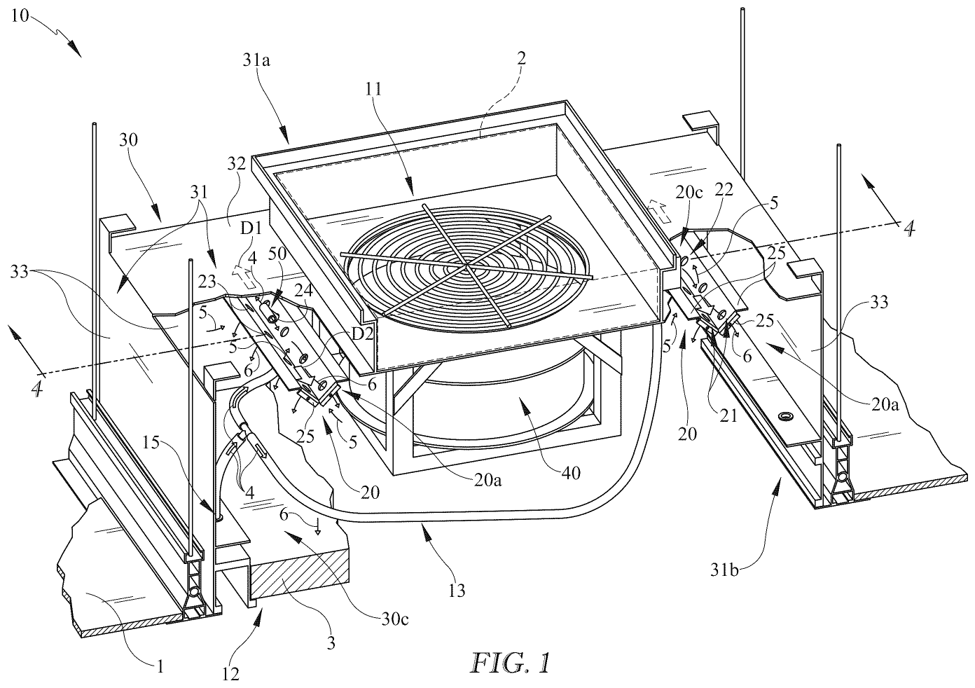

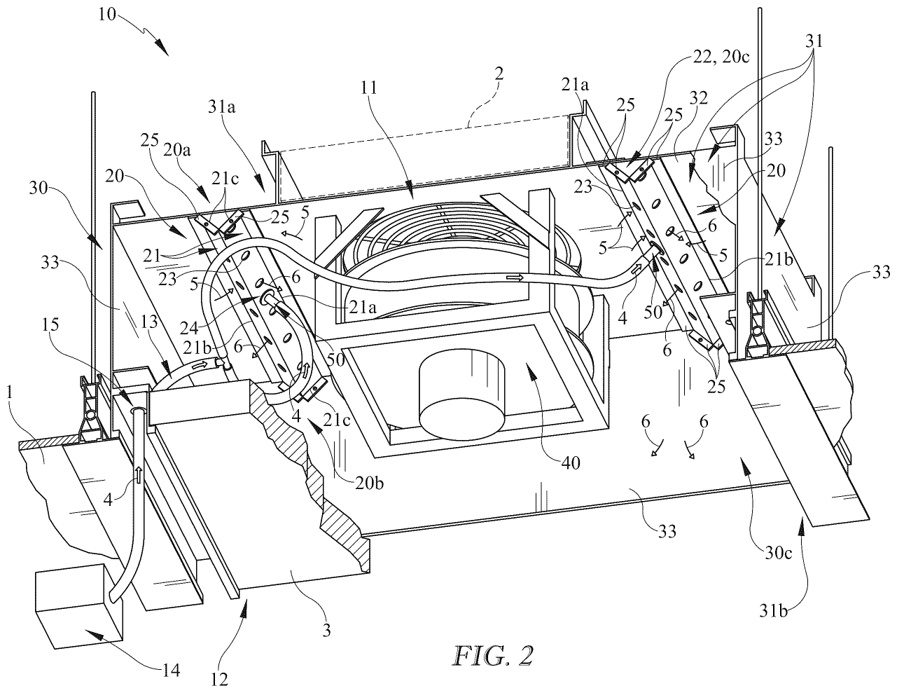

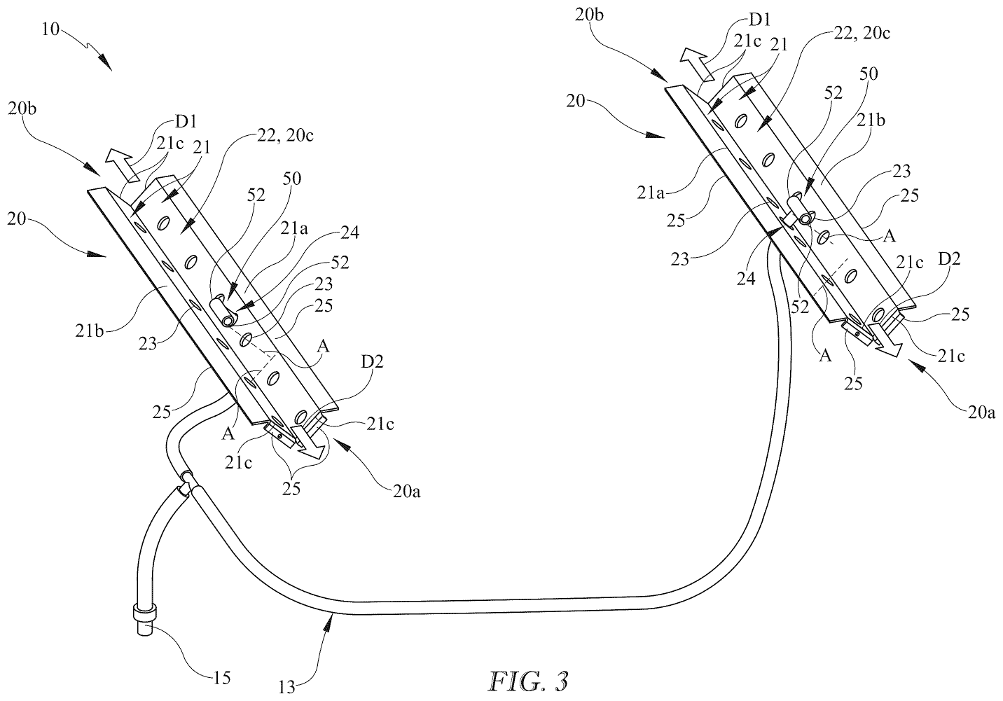

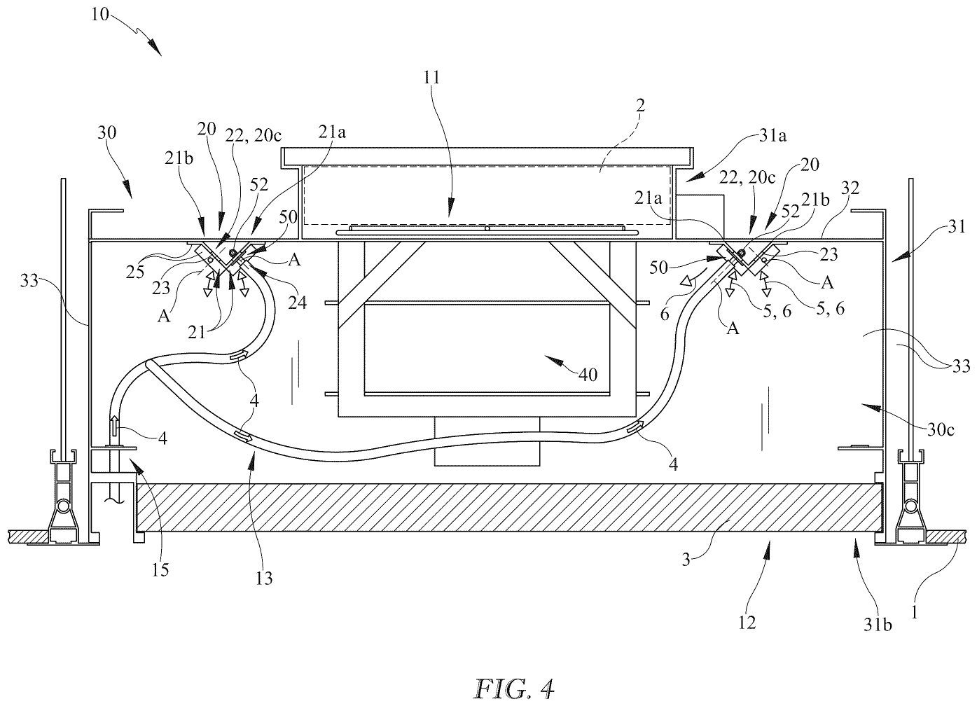

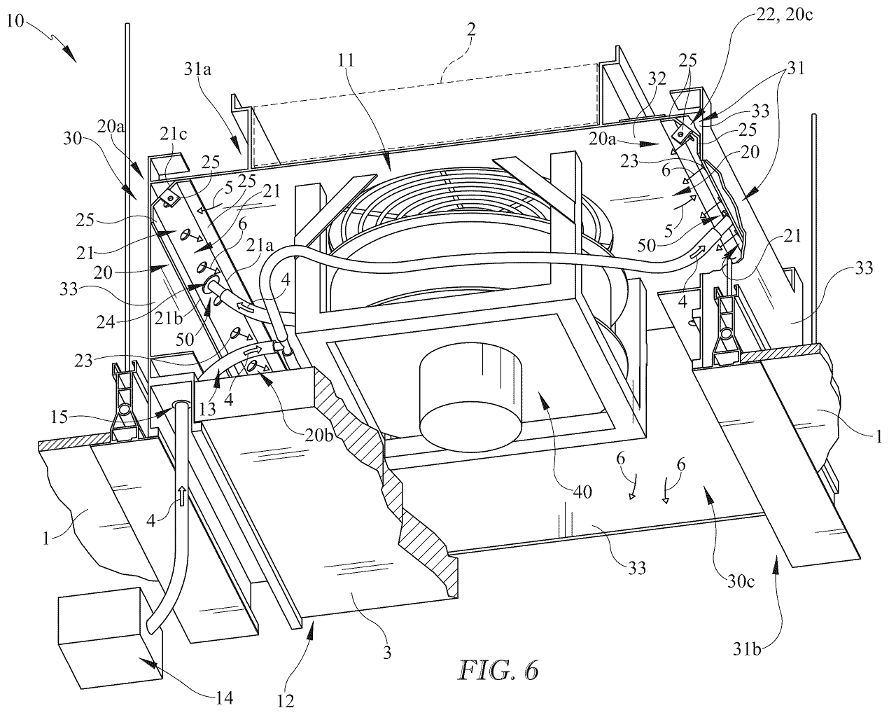

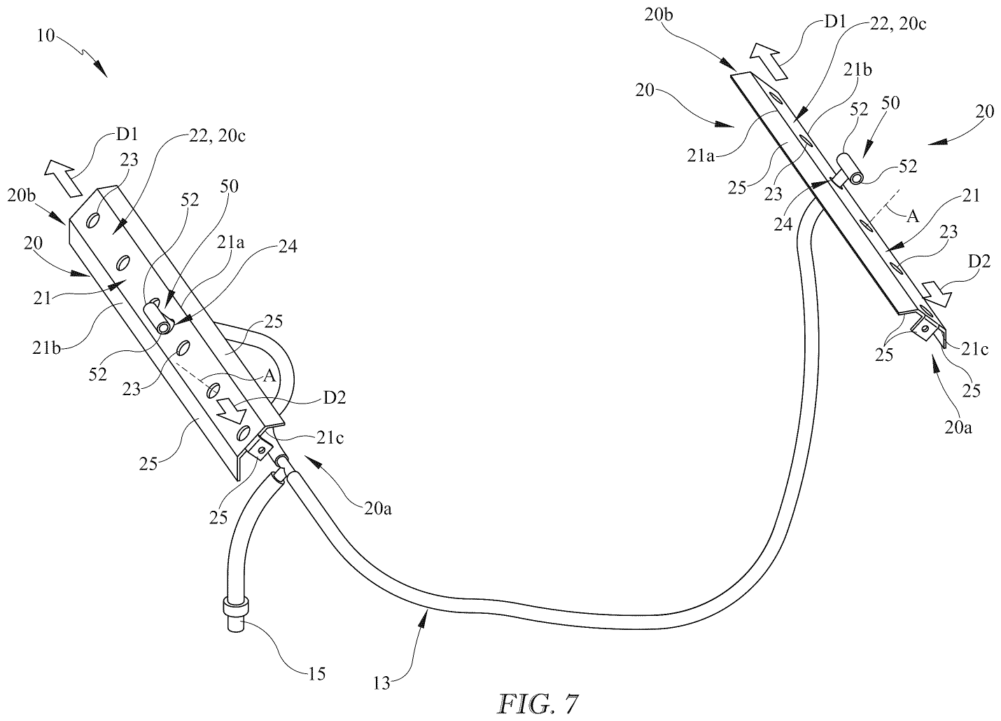

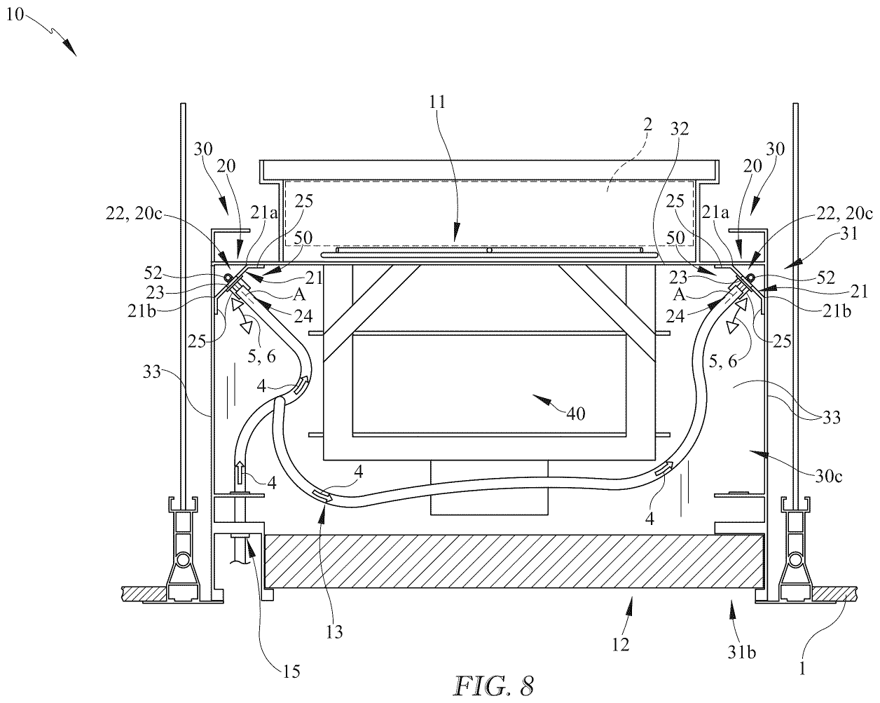

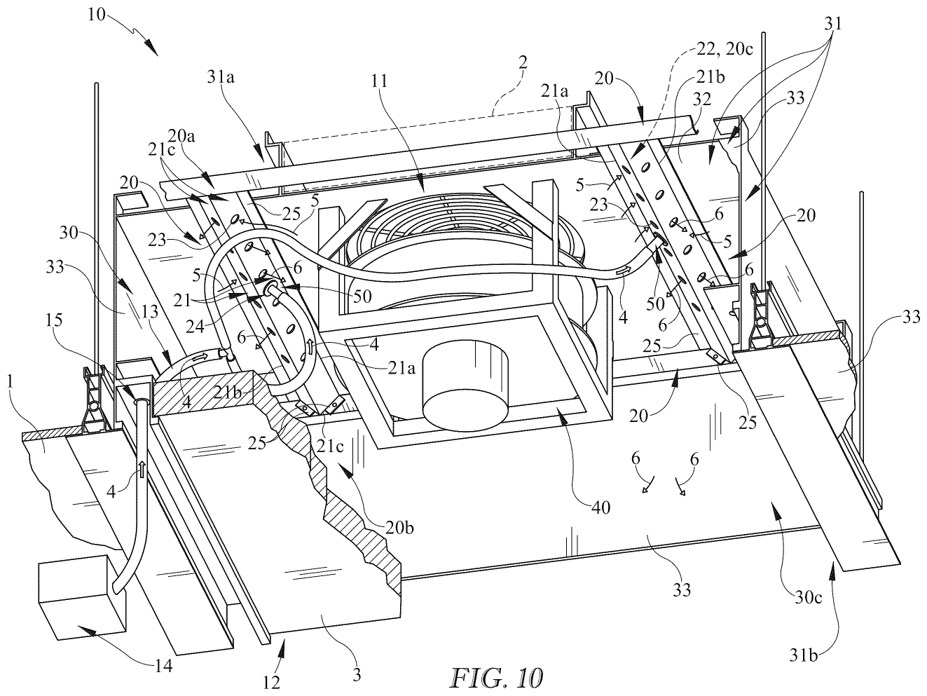

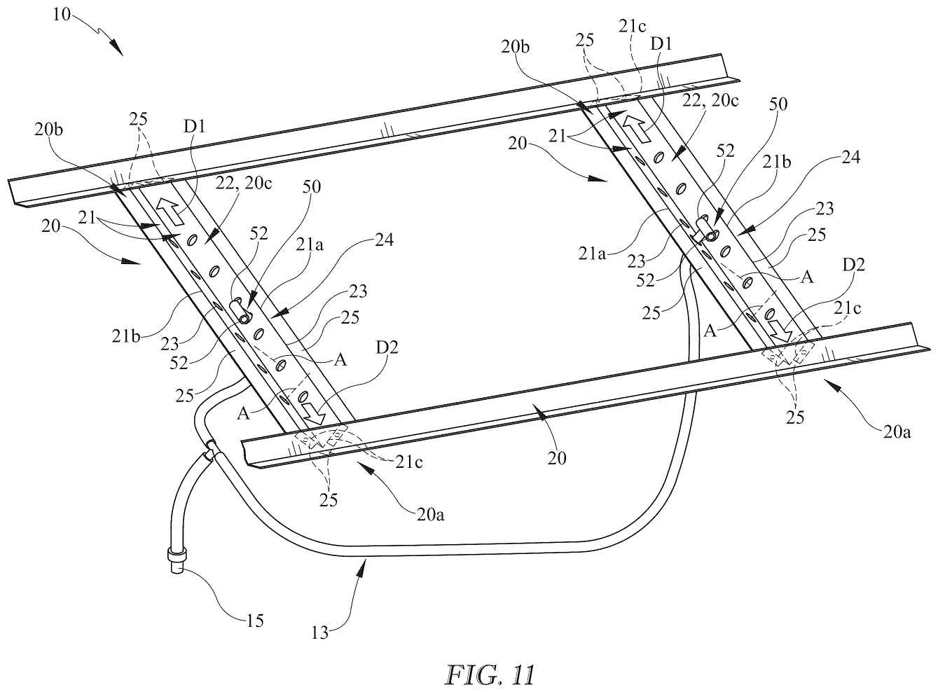

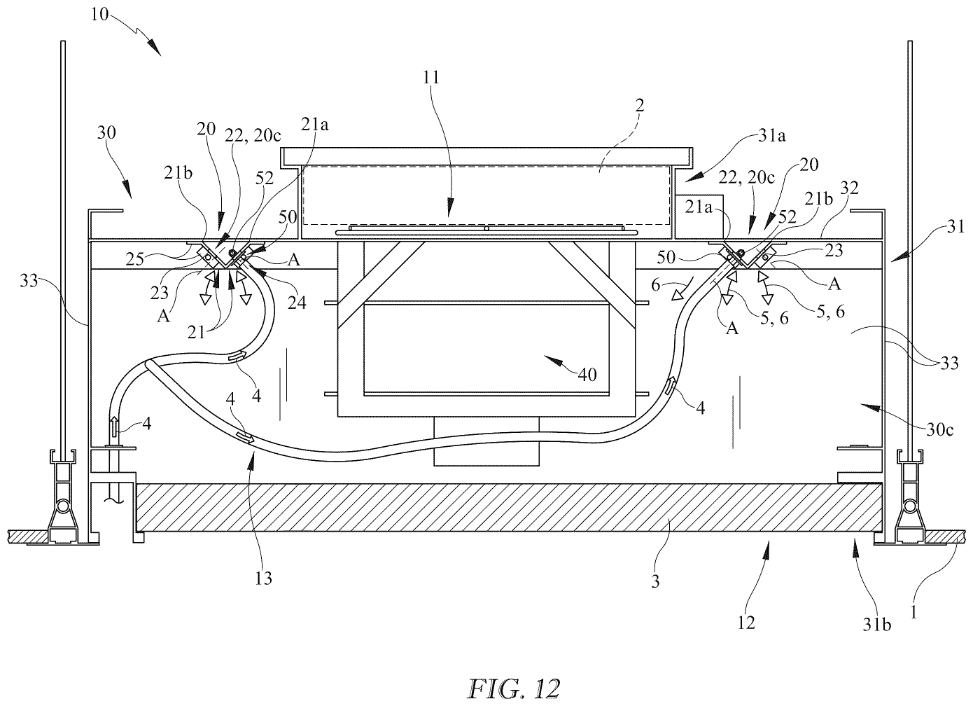

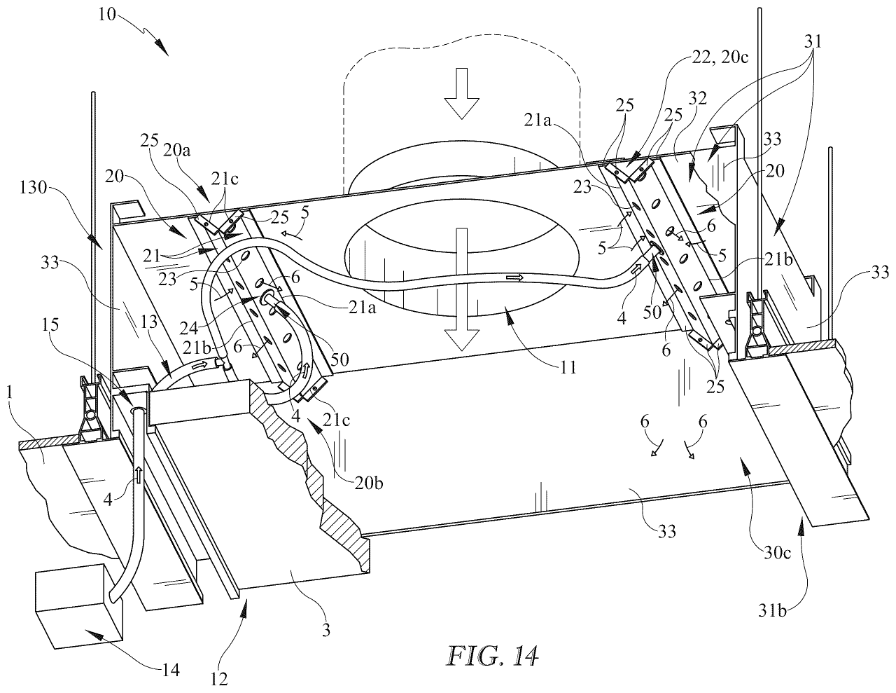

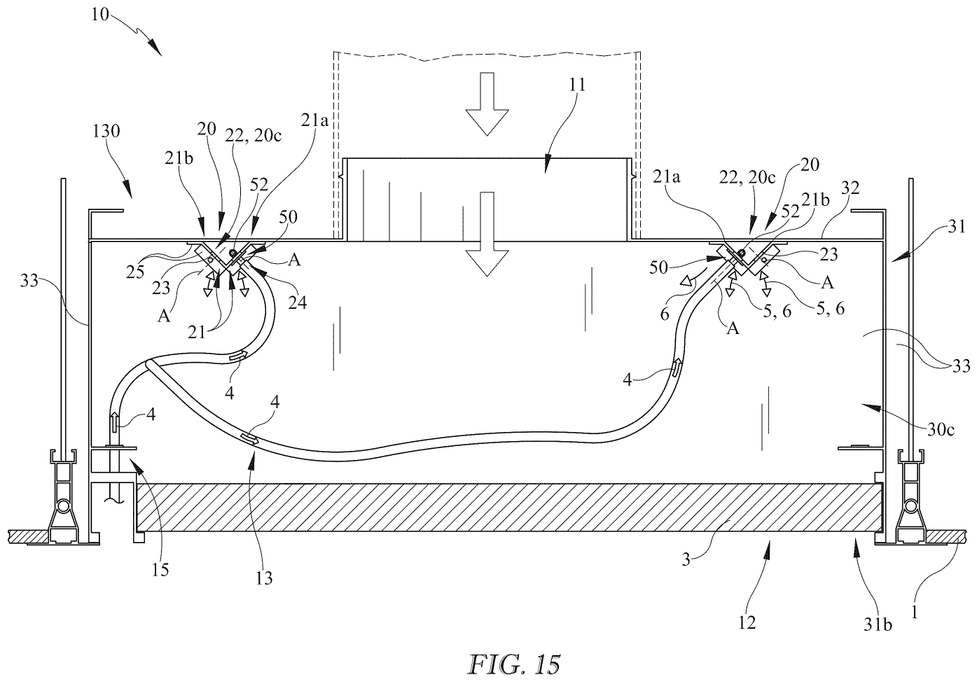

Turning to the drawings, wherein like numbers denote like parts throughout the several views, FIGS. 1-16 illustrates an example filter unit 10, or portions thereof, in which the various technologies and techniques described herein may be implemented. As shown in FIGS. 1-12, the filter unit 10 and/or filter housing 30 may include an air circulating device(s) 40 (e.g. fan, blower, backward incline fan) and one or more aerosol injectors 20 that may be installed in a structure 1, such as a ceiling, wall or floor of a room, a machine enclosure, mini-environment or other surface bounding an area requiring delivery of filtered air. The aerosol injector(s) 20 may be located to provide aerosol into the airstream downstream of the air circulating device 40, if used.

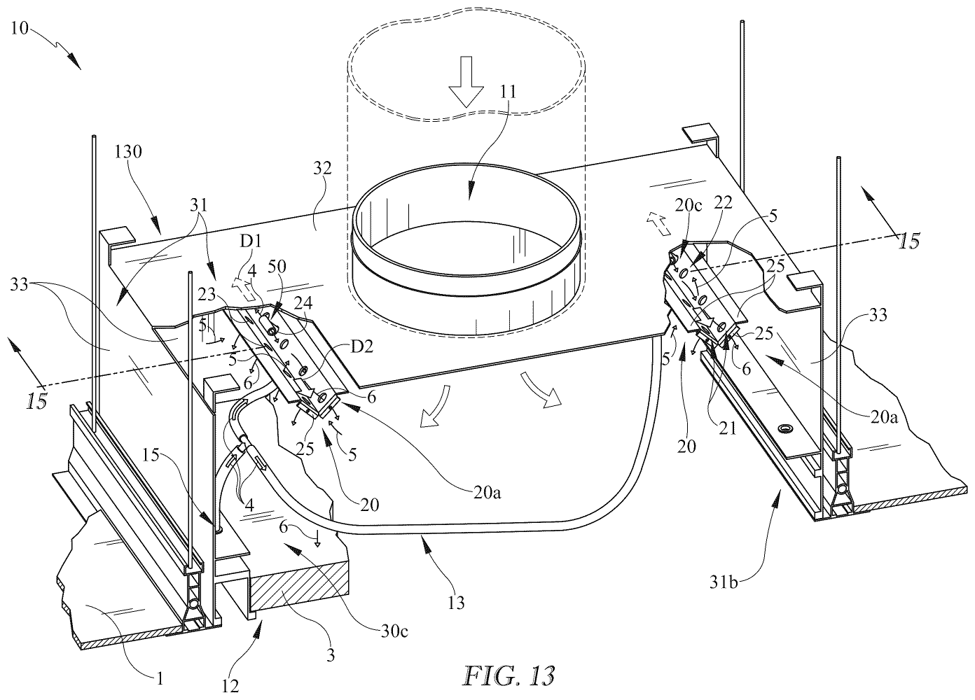

The aerosol injector(s) 20 may be downstream and/or positioned radially outward from the air circulating device 40 and/or inlet 11. The filter unit 10 and/or filter housing 30, 130, 230 may include one or more filters 2, 3. A prefilter(s) 2, if used, may be adjacent an inlet 11 to the housing 30 and/or received by a filter receptacle 31a, if used. One or more filters 3 (e.g. final, one or more stages) may be adjacent an outlet 12 and/or received by a filter receptacle 31b. The filter receptacle(s) 31a, 31b may allow filter(s) 2, 3 to be removed/replaced from the housing 30 and/or filter unit 10. The injector may be made of a variety of material such as, but is not limited to, aluminum. As shown in FIGS. 13-16, the filter unit 10 and/or filter housing 130, 230 may include one or more aerosol injectors 20 that may be installed in a structure 1, such as a ceiling, wall or floor of a room, a machine enclosure, freestanding, mini-environment or other surface bounding an area requiring delivery of filtered air. The filter housing 130, 230 may not include an air circulating device therein.

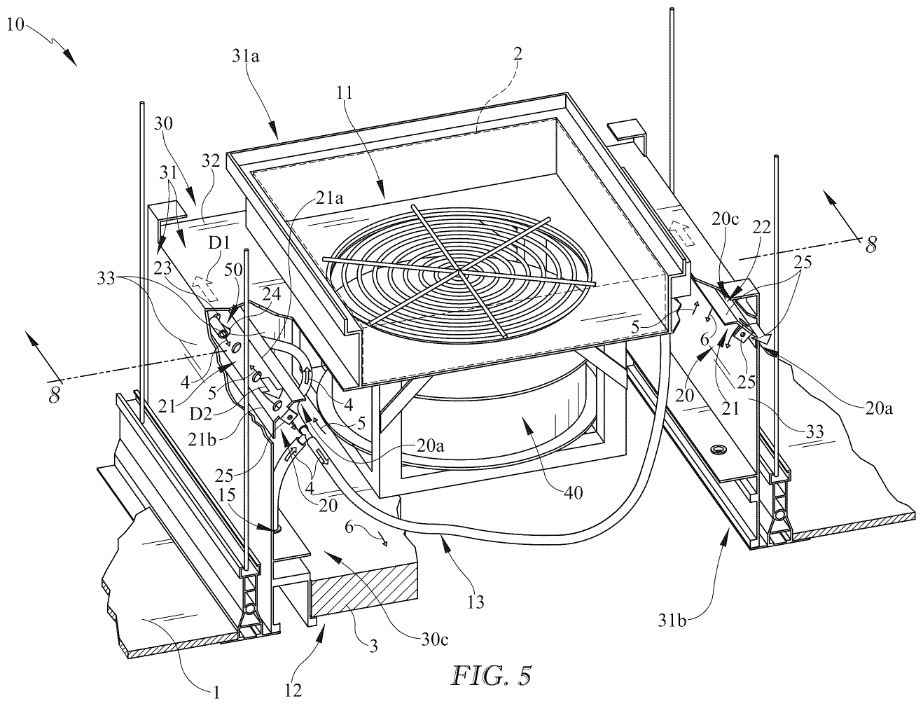

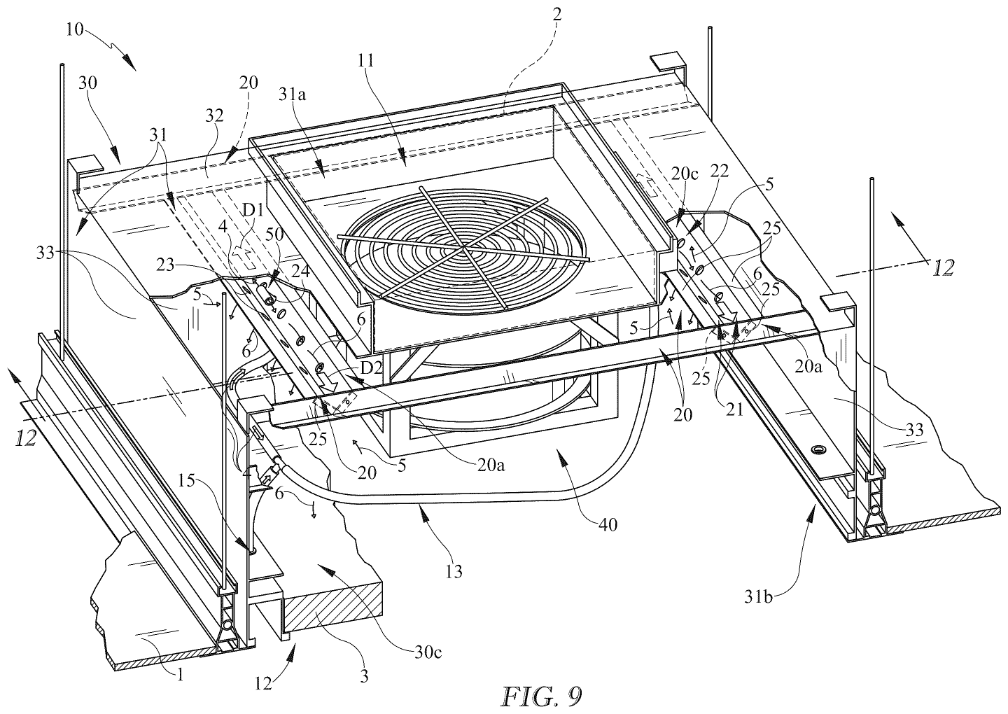

In some implementations, the filter unit 10 and/or filter housing 30, 130, 230 may include one or more support struts or aerosol injectors 20. As shown in the Figures, the injector(s) 20 may be one or more reinforcement or support struts of one or more portions (e.g. wall(s), surfaces) of the filter housing 30. The injector 20 may reinforce, stiffen, hold, or support the one or more housing walls 31, (e.g. top wall 32, side wall 33, bottom wall 34) and/or other portions of the filter housing 30 in combination with distributing aerosol challenge, as needed. The injector 20 may be engaged/positioned adjacent to or abut directly against one or more housing walls 31 (e.g. side wall 33, top wall 32, bottom wall) or interior periphery of the housing 30, or portions thereof, defining the interior volume 30c (e.g. first) of the filter housing 30. One or more ends, sides, and/or edges of the injector 20 may be defined by or engage one or more walls/surfaces 31, 32, 33 of the filter housing (e.g. interior periphery, side wall, top wall, another injector, support strut), or portions thereof. As shown in FIGS. 1-4, 9-12, and 13-16, the injector 20 and/or longitudinal edges 21a, 21b, or portions thereof (e.g. walls 21, ends 20a-b), may support/engage or be positioned against the top wall 32. As shown in FIGS. 5-8, the injector 20 and/or longitudinal edges 21a, 21b, or portions thereof (e.g. walls 21, ends 20a-b), may support/engage or be positioned against both the top wall 32 and one or more side walls 33 (e.g. corner). Although not shown, the injector 20 and/or longitudinal edges 21a-b, or portions thereof (e.g. walls, ends), may support/engage or be positioned against the one or more side walls(e.g. only). The one or more opposing ends 20a, 20b of the injector 20 (e.g. linear, elongated) may be defined by, support/engage, and/or be positioned against the one or more housing walls (e.g. side wall(s) 33, top wall 32), or portions thereof (e.g. support strut 20). For example, another support strut (e.g. 20) may define or engage at least one end 20a-b of the injector 20 (e.g. support strut). As shown in FIGS. 1-8 and 13-16, the opposing ends 20a and 20b of the injector 20 may support/engage or abut one or more side walls 33 (e.g. opposing). As shown in FIGS. 9-12, the opposing ends 20a and 20b of the injector 20 may support/engage or abut another support strut 20 (e.g. injector having openings, without opening(s) as shown).

In some implementations, the one or more struts/injectors 20 may include one or more walls 21. The one or more walls 21 may define at least a portion of one or more mixing chambers 22. The mixing chamber 22 defines or may be another/second interior volume 20c. The mixing chamber 22 may provide an area/volume that aerosol 4 (e.g. injected) and air 5 (e.g. forced, downstream air from the air circulating device 40) may mix together. The aerosol and air mixture 6 may provide for more consistent distribution of aerosol downstream of the injector(s) 20 and/or across the face of the filter 3. The mixing chamber 22 receives aerosol 4 (e.g. pressurized) from the upstream tubing 13/aerosol generator 14/port 15 and air 5 (e.g. forced) from the air circulating device 40, if used, and/or upstream/downstream from the housing. The air 5 (e.g. forced) may enter the second interior volume 20c and/or mixing chamber 22 through one or more openings 23 within the injector 20 (e.g. wall(s) 21). The aerosol 4 may enter the second interior volume 20c and/or mixing chamber 22 through an opening/port 24, or more specifically from a fitting 50 (e.g. T-shaped, one inlet to two outlets), if used. The aerosol 4 upstream from the injector 20 (e.g. within fitting 50, within tubing/tubes 13) may be considered pressurized. The aerosol 4, once injected into the mixing chamber 22, before or after mixing with air 5 within the mixing chamber 22 may be considered unpressurized. Once the aerosol 4 and air 5 is mixed or combined within the injector 20 (e.g. mixing chamber 22, second interior volume 20c), the mixture or challenge 6 may exit through the one or more openings 23 (e.g. defined by 21, 31, or both). At least two opposing opening(s) 23 (e.g. within opposing/different walls 21) may assist in mixing the air 5 and aerosol 4 within the mixing chamber 22 or injector 20. In some embodiments, one or more openings 23 adjacent the air circulating device 40 may intake air 5 and the one or more openings 23 distal the air circulating device 40 may dispense the mixture of air and aerosol 6. However, it should be understood that flow may be in and/or out of the one or more openings 23 in a variety of positions. For example, a single opening may be both an inlet and an outlet to the mixing chamber 22.

In some implementations, the injector 20 and/or mixing chamber 22 includes or is defined by one or more walls (e.g. injector wall 21, housing wall 31). The injector 20 may include one or more walls 21, 31 defining the mixing chamber 22. The walls 21, 31 may include the one or more openings 23 and/or ports 24. One or more housing walls 31 of the housing 30 may define a portion of the one or more mixing chambers 22 in some embodiments. Although the housing walls 31 are shown as not containing openings 23, it should be understood that the housing walls 31, or portions thereof, (e.g. internal to the external walls) may include openings in some embodiments. In the embodiments shown, one or more walls 21 of the injector 20 and one or more housing walls 31 of the housing define the mixing chamber 22 or second interior volume 20c. The top wall 32 and/or the one or more side walls 33 may define a portion of the one or more mixing chambers 22. As shown in FIGS. 1-4, 9-12 and 13-16, at least the top wall 32 of the housing 30 and the one or more walls 21 (e.g. two opposing walls, elongated edges) of the injector 20 define the mixing chamber 22. Both elongated edges 21a and 21b (e.g. flange) of the injector walls 21 engage the top wall 32. Further, as shown in the one embodiment in FIGS. 1-4 and 13-16, opposing side walls 33 (e.g. perpendicular to the length/direction of the injector 20) of the housing 30 may close or define the ends 20a and 20b of the injector and/or mixing chamber. It should be understood that the side wall(s) 33 may not close the one or more ends 20a, 20b of the mixing chamber 22 in some embodiments, such that only the top wall 32 defines the remaining portion of the injector. For example, the injector may not extend from side wall to side wall in some embodiments. In some embodiments as shown in FIGS. 9-12, another or second support strut 20 (e.g. with openings, without openings as shown) may close or define the ends 20a, 20b of the injector 20 and/or mixing chamber 22. As shown in FIGS. 5-8, at least the top wall 32 and the side wall 33 (e.g. one side wall) of the housing 30 and the one or more walls 21 (e.g. two opposing walls, elongated edges) of the injector define the mixing chamber 22. One elongated edge 21a (e.g. flange) of the injector wall engages the top wall 32 and another elongated edge 21b (e.g. flange) of the injector wall 21 engages the side wall 33, creating a corner positioned injector 20. Further, opposing side walls 33 (e.g. perpendicular to the length/direction of the injector) of the housing 30 may close or define the end(s) 20a, 20b of the injector 20 and/or mixing chamber 22. It should be understood that the side wall(s) 33 may not close the one or more ends 20a, 20b of the mixing chamber 22 in some embodiments, such that only the top wall and corresponding side wall defines the remaining portion of the injector. For example, the injector may not extend from side wall to side wall in some embodiments. For example, the one or more ends may be open. For example, one or more walls 21 of the support strut 20 may define the one or more ends/walls of the chamber.

In some implementations, the injector 20 may include one or more walls projecting from or engaging/supporting the housing wall(s) 31. The one or more walls 21 may include the one or more openings 23 (e.g. inlet, outlet, both). The one or more openings 23 are in communication between the one or more mixing chambers 22, second interior volume 20c, and/or the interior volume 30c (e.g. first, housing, remaining volume/portion of the housing). Although the one or more walls 21 may be substantially planar as shown in the embodiments, it should be understood that the wall 21 may be of a variety of shapes, sizes, quantities, and constructions and still be within the scope of the invention. For example, the injector walls/compartment/chamber may be two walls 21 (e.g. at top wall) in combination with the housing wall(s) 31 (e.g. top wall, side wall(s)) as shown in FIGS. 1-4 and 9-16. Another example, the injector wall/compartment/chamber may include a single wall 21 (e.g. at the top corner(s)) in combination with the housing wall(s) 31 (e.g. top wall, side wall(s)) as shown in FIGS. 5-8. The one or more walls 21 may project or depending from at least the top wall 32 in some embodiments. The one or more walls 21 may be angled or transverse to the top wall 32 and/or side wall 33 (e.g. plane). A wall 21 may project from and/or be angled to both the side wall 33 and top wall 32. Two walls 21 in some embodiments may be angled (e.g. acute) relative to each other. For example, two walls 21 as shown in FIGS. 1-4 and 9-16 may depend at an angle from the top wall 32 of the housing 30. The walls 21 of the injector 20 and the walls 31 of the housing 30 may define a cross section of the mixing chamber that is substantially non-arcuate. For example, the cross section of the mixing chambers may be triangular in shape as shown in some embodiments. Although, arcuate in cross section is contemplated. In some embodiments, the injector 20 and/or one or more walls 21 may include one or more flanges 25. The flanges 25, if used, may project from the one or more walls 21 (e.g. edges 21a, 21b, 21c, ends 20a, 20b, surfaces) to engage the one or more of the housing wall(s) 31 (e.g. top wall(s), side wall(s)). The flanges 25, if used, may extend from one or more surfaces or edges 21a, 21b, 21c of the one or more walls 21. The flanges 25 may engage or be parallel to the one or more surfaces of another strut wall, top wall 32, and/or side wall 33 as shown. The flanges 25 may be fixed to the one or more housing walls 31 (e.g. top wall, side wall) and/or another strut wall. The flanges 25 may be welded, fastened, riveted, etc. to the housing wall(s) 31, however a variety of attachment mechanisms may be used. As shown in FIGS. 1-4 and 9-16, a flange 25 may extend from each opposing longitudinal edges 21a, 21b to each engage the top wall 32, respectively. As shown in FIGS. 5-8, a flange 25 may extend from opposing longitudinal edges 21a, 21b to engage the side wall 33 and the top wall 32, respectively. In some embodiments as shown in the Figures, the walls/ends/edges 21c (e.g. edges between or adjacent the longitudinal edges 21a, 21b) of the injector defining the ends 20a, 20b of the injector 20 may include one or more flanges/tabs 25 to engage the side wall 33/wall 31/another strut 20. The edges 21c may engage or contact the side wall(s) 33. The one or more flanges may extend along one or more portions of the edge(s) 21a, 21b, and/or 21c. The flange may extend the entire length of the edge in some embodiments. The flange may extend for a portion of the length of the edge in some embodiments.

In some implementations, the injector 20 and/or walls 21, or portions thereof, may include one or more openings 23 therein. The one or more openings 23 may be a variety of shapes, sizes, quantities, and constructions and still be within the scope of the invention. The axis A of an opening may be positioned transverse to or at an angle relative to the top wall 32 in some embodiments. As shown in FIGS. 1-4 and 9-16, the axis A of an opening 23 of two adjacent injector walls 21, respectively, may be transverse to or angled relative to each other. Further, the axis A may be angled relative to a side wall 33. As shown in FIGS. 5-8, the axis A of the opening 23 may be angled or transverse to the top wall 32 and/or the side wall 33 and/or away from the side wall/corner towards the air circulating device 40. Although the ends 20a, 20b of the injector are shown as closed, the ends of the injector may be open and/or include one or more openings in some embodiments.

In some implementations, the filter unit 10, injector 20, and/or filter housing 30, 130, 230 may include one or more housing walls 31. The housing 30 and/or housing wall(s) 31 may be configured to position one or more air circulating devices 40, if used, and/or one or more filters 2, 3. The one or more housing walls 31 may define an interior periphery, mixing chamber 22, interior volume 20c, and/or interior volume 30c (e.g. first), or portions thereof. In some embodiments as shown, the housing walls 31 may include a top wall 32 and at least one side wall 33. The side walls 33 may be a plurality of side walls as shown in the Figures, however a single side wall (e.g. arcuate) may be used in some embodiments. The side wall(s) 31 may be substantially perpendicular to the top wall 32. The filter housing 30 and/or wall(s) 31 may define one or more inlets 11, one or more filter receptacles 31a, 31b, and/or one or more outlets 12. The wall(s) 31 and/or side wall(s) 33 may define at least a portion of the filter receptacle 31b and/or outlet 12. The wall(s) 31 and/or top wall 32 may include or define at least a portion of the filter receptacle 31a, if used, and/or the inlet 11.

In some implementations, an aerosol delivery tube/tubing 13 may be routed through the interior volume 30c of the filter housing 30. The aerosol delivery tube 13 may be coupled to the aerosol injector 20 (e.g. wall 31, fitting 50, port 24), or portions thereof. The aerosol delivery tube 13 is in fluid communication at an aerosol access port 15 accessible from the room side, e.g., filter receiving aperture/receptacle 31b side, of the housing 30. In one embodiment, the aerosol access port 15 extends through at least one portion of the housing 30. The aerosol access port 15 may be utilized to connect the aerosol injector 20 to an aerosol generator 14. The aerosol access port 15 is generally sealable, either through an internal check valve or with a stopper (not shown). The aerosol generator 14 may be utilized to supply an aerosol challenge to the upstream side of the filter 3 in the interior volume 30c to enable a statistically valid test of the filter 3. As shown in the embodiments, the tube/tubing 13 extending from the port 15 splits downstream to supply at least two aerosol injectors 20. It is contemplated that one aerosol injector 20 may be used or more than two in some embodiments to support the one or more portions of the housing 30 and/or inject/mix aerosol into the housing 30. The downstream injectors 20 may be positioned downstream of the air circulating device or fan/blades. For example, radially outside/downstream from the fan (e.g. blades), motor, and/or inlet, etc.

In some implementations, the filter housing 30, unit 10, and/or injector 20 may include one or more ports, nozzles, or fittings 50. The fitting 50, if used, may be used to inject aerosol into the injector, interior volume 20c, and/or mixing chamber 22. The one or more ports/nozzles/fittings 50 may be positioned (e.g. within one or more openings/mixing chamber/injector, ports 24) to dispense aerosol into the air 5 (e.g. forced, air entering, air leaving, air in fluid communication through the one or more openings) within the mixing chamber 22. The fitting 50 may be in downstream communication with the one or more aerosol delivery tubes 13 to the aerosol access port 15 accessible from outside the housing. In one embodiment, the aerosol injector 20 includes the fitting 50 positioned through at least one opening/port 24. The port 24/fitting 50 may be spaced away from or between the one or more ends 20a and 20b of the aerosol injector 20, openings 23, and/or side walls 33. As shown, the fitting 50 and/or outlet(s) 52 may be positioned/spaced inwardly and away from (e.g. radially inward) from the wall(s) 21, 31. The fitting 50 may direct aerosol within the mixing chamber 22 in one or more directions D1, D2/orientations and/or include one or more outlets 52. In one embodiment depicted in FIGS. 1-16, the fitting 50 directs aerosol (e.g. pressurized) into the mixing chamber 22 or injector 20 in two opposing directions D1, D2. The direction D1, D2 may be in the longitudinal direction along the length of the mixing chamber 22 or injector 20 (e.g. perpendicular to the axis of the inlet/fan) and/or parallel to the top wall 32 or face of the filter 3. One fitting 50 may be used for a single mixing chamber 22 or injector 20 in some embodiments. However, other constructions are contemplated. For example, the fitting 50 may discharge directly into the mixing chamber 22 adjacent the wall 21 and/or in a direction perpendicular to the wall plane. The fitting 50 may be T-shaped as shown in the one embodiment. The fitting may include at least two outlets. As shown in the one embodiment, the fitting 50 may include two opposing outlets 52. The axis of outlets (e.g. one, two, etc.) may be substantially parallel to the longitudinal axis of the injector 20/chamber 22. The one or more outlets 52 (e.g. axis) may be positioned/spaced inwardly and away from (e.g. radially inward) from the interior or wall 21 of the injector/mixing chamber. The fitting 50, if used, may space the one or more outlets 52 into the mixing chamber 22 away from (e.g. inwardly) the one or more walls 21, 31 of the one or more aerosol injectors 20 and/or housings 30, respectively. As shown in the Figures, the fitting 50 may not separate or communicate with two separate mixing chambers 22. The fitting (e.g. one or more outlets) may communicate with a single mixing chamber or injector (e.g. between end 20a to end 20b). For example as shown, the two or more outlets 52 communicate into the same or single mixing chamber 22 (e.g. between end 20a to end 20b). In some embodiments, the pressure in upstream fitting 50 and/or aerosol tube(s) 13 may be higher than downstream mixing chamber 22.

In some applications in use, the method of injecting aerosol in a filter housing 30 may include injecting aerosol to the one or more support struts/injectors 20 from an aerosol access port 15 accessible from outside the filter housing 30. In some embodiments, the method may include providing a filter housing 30. In various embodiments, the filter housing 30 may include one or more housing walls 31 defining an interior volume 30c and one or more support struts or injectors 20 adjacent to and supporting the one or more housing walls 31. In some embodiments, the one or more support struts 20 may include one or more openings 23 therein. In various embodiments, injecting aerosol in opposing directions D1 and D2 within a mixing chamber 22 (e.g. single) defined by the one or more housing walls 31 and/or the one or more support struts 20 (e.g. walls). In some embodiments, the method may include communicating aerosol through the one or more openings 23. In various embodiments, the one or more openings 23 may be transverse to a top wall 32 of the one or more housing walls 31 of the filter housing 30 from the one or more support struts 20 to the interior volume 30c. In some embodiments, the method may include mixing the injected aerosol 4 and air 5 (e.g. forced, not forced) in the mixing chamber 22 (e.g. single). In various embodiments, the mixing chamber 22 may be defined by the one or more housing walls 31 of the filter housing and/or one or more walls 21 of the one or more support struts 20. For example, the mixing chamber may be defined by only the wall(s) 21 of the support strut 20. In another example, the mixing chamber may be defined by the wall(s) 21 of the support strut 20 and the wall(s) 31 of the filter housing 30.

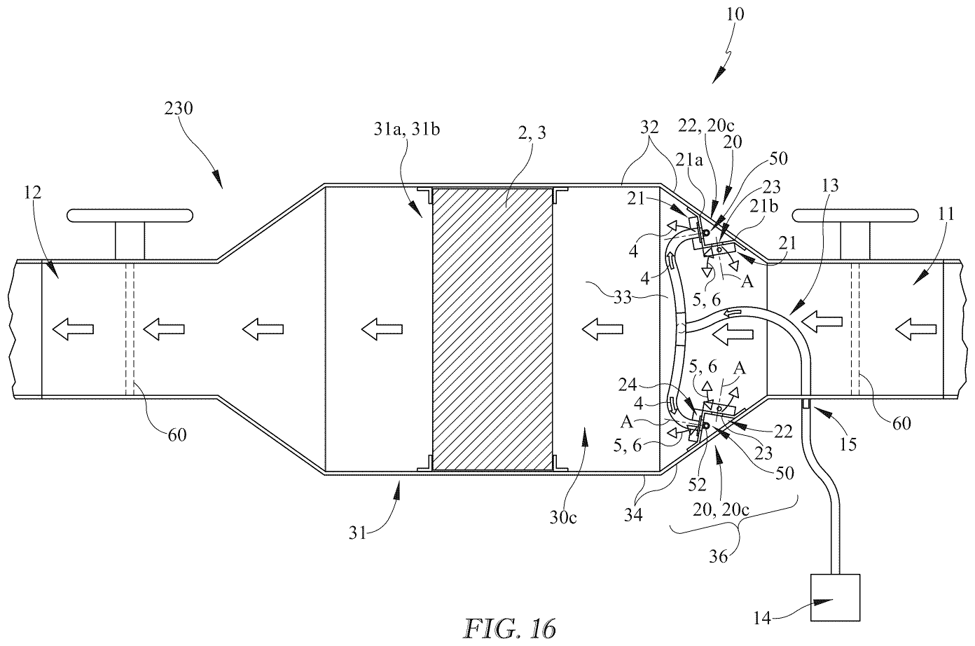

Although an air circulating device(s) 40 may be used in some applications as shown in FIGS. 1-12, it should be understood that in some implementations the filter housing 30, 130, 230 and/or support strut(s) 20 may not include an air circulating device. The air circulating device(s) may be positioned upstream and/or downstream of the inlet 11/outlet 12 of the filter housing 30, 130, 230 and still communicate air 5 to/from the strut 20/housing 130, 230. For example as shown in the one embodiment in FIGS. 13-15, the filter housing 130 may not include an air circulating device. The filter housing 130 may include one or more injectors/struts 20 in one or more positions/constructions (e.g. such as shown in FIGS. 1-12). The filter housing 130 may be a ducted ceiling module in some embodiments (e.g. ASTROHOOD ceiling module commercially available from AAF). The filter housing 130 may be free from the air circulating device, such that the air circulating device may be positioned upstream and/or downstream of the filter housing 130. Further as shown in the one embodiment in FIG. 16, the filter housing 230 may not include an air circulating device. The filter housing 230 may include one or more injectors/struts 20 in one or more positions. For example, the strut/injector 20 may be positioned in the inlet transition housing 36 (e.g. tapering housing walls, bottom wall, top wall, side wall) as shown and/or other positions within the housing upstream of the filter(s). A strut(s) 20 may be positioned adjacent at least the top wall 32 of the housing walls 31 and another strut(s) 20 may be positioned adjacent at least the bottom wall 34. The filter housing 230 may be a containment housing (e.g. ASTROSAFE containment unit commercially available from AAF). In some embodiments, the unit/housing 30, 130, 230 may include one or more dampers 60 (e.g. adjacent the inlet, adjacent the outlet, guillotine). As shown in FIG. 16, the inlet 11 may include one or more dampers 60 and/or the outlet 12 may include one or more dampers 60.

While several embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

It is to be understood that the embodiments are not limited in its application to the details of construction and the arrangement of components set forth in the description or illustrated in the drawings. The invention is capable of other embodiments and of being practiced or of being carried out in various ways. Unless limited otherwise, the terms “connected,” “coupled,” “in communication with,” and “mounted,” and variations thereof herein are used broadly and encompass direct and indirect connections, couplings, and mountings. In addition, the terms “connected” and “coupled” and variations thereof are not restricted to physical or mechanical connections or couplings.

The foregoing description of several embodiments of the invention has been presented for purposes of illustration. It is not intended to be exhaustive or to limit the invention to the precise steps and/or forms disclosed, and obviously many modifications and variations are possible in light of the above teaching.

1. A filter housing comprising:
a housing having a plurality of housing walls defining an interior volume, wherein the housing is configured to position one or more filters; and
one or more aerosol injectors having one or more walls defining one or more mixing chambers, and wherein the one or more aerosol injectors is one or more support struts of one or more housing walls of the plurality of housing walls.

2. The filter housing of claim 1 further comprising an air circulating device, wherein the housing is configured to position the air circulating device relative to one or more filters.

3. The filter housing of claim 1 wherein the one or more housing walls of the plurality of housing walls define a portion of the one or more mixing chambers.

4. The filter housing of claim 1 further comprising a fitting having at least two outlets within the one or more mixing chambers of the one or more aerosol injectors directing aerosol in opposing directions.

5. The filter housing of claim 4 wherein the at least two outlets include two opposing outlets, wherein an axis of the two opposing outlets, respectively, is substantially parallel to a longitudinal axis of the one or more aerosol injectors.

6. The filter housing of claim 1 wherein the one or more housing walls include at least one side wall and a top wall.

7. The filter housing of claim 6 wherein the one or more mixing chambers is defined by at least the top wall and/or the at least one side wall.

8. The filter housing of claim 7 wherein the one or more mixing chambers is defined by the top wall.

9. The filter housing of claim 7 wherein the one or more mixing chambers is defined by the top wall and the at least one side wall.

10. The filter housing of claim 1 wherein the one or more walls of the aerosol injector is planar, and the one or more walls include a plurality of openings in communication between the one or more mixing chambers and the interior volume.

11. The filter housing of claim 10 wherein two walls of the one or more walls include at least one opening of the plurality of openings, wherein an axis of the at least one opening of each of the two walls are transverse to each other.

12. The filter housing of claim 1 wherein the one or more mixing chambers is non-arcuate in cross section.

13. The filter housing of claim 1 wherein the aerosol injector includes one or more flanges projecting from the one or more walls engaging the one or more housing walls.

14. A filter housing comprising:
a housing having a top wall and one or more side walls defining an interior volume, wherein the housing is configured to position one or more filters; and
one or more aerosol injectors having one or more walls defining one or more mixing chambers, and wherein the one or more aerosol injectors is one or more support struts of at least one of the top wall and/or one or more side walls.

15. The filter housing of claim 14 further comprising an air circulating device, wherein the housing is configured to position the air circulating device relative to one or more air filters.

16. The filter housing of claim 14 wherein the one or more mixing chambers is defined by at least the top wall.

17. The filter housing of claim 16 wherein the one or more mixing chambers is defined by at least the top wall and the one or more side walls.

18. The filter housing of claim 14 wherein the one or more side walls and/or one or more support struts define one or more ends of the one or more aerosol injectors.

19. The filter housing of claim 14 wherein the one or more aerosol injectors includes a fitting, wherein the fitting spaces one or more outlets into the mixing chamber away from the one or more walls of the one or more aerosol injectors.

20. The filter housing of claim 19 wherein the fitting is in downstream communication with one or more aerosol delivery tubes to an aerosol access port accessible from outside the housing.

21. The filter housing of claim 14 wherein the one or more walls of the aerosol injector include a plurality of openings in communication between the one or more mixing chambers and the interior volume and one or more flanges projecting from the one or more walls engaging at least one of the top wall and/or one or more side walls.

22. A method of injecting aerosol in a filter housing comprising the steps of:
providing a filter housing having one or more housing walls defining an interior volume and one or more support struts adjacent to and supporting the one or more housing walls, the one or more support struts include one or more openings therein; and
injecting aerosol to the one or more support struts from an aerosol access port accessible from outside the filter housing.

23. The method of claim 22 further comprising injecting aerosol in opposing directions within a mixing chamber defined by the one or more support struts.

24. The method of claim 23 wherein the mixing chamber is defined by the one or more housing walls and the one or more support struts.

25. The method of claim 22 further comprising communicating aerosol through the one or more openings transverse to a top wall of the one or more housing walls of the filter housing from the one or more support struts to the interior volume.

26. The method of claim 22 further comprising mixing the injected aerosol and air in a mixing chamber defined by the one or more housing walls of the filter housing and one or more walls of the one or more support struts.

27. The method of claim 22 wherein the filter housing further includes one or more air circulating devices in fluid communication with the one or more support struts.
